(19) United States
(12) Patent Application Publication
(10) Pub. No.: US 2014/0337802 A1
(43) Pub. Date: Nov. 13, 2014

(54) INTUITIVE GESTURE CONTROL

(71) Applicant: SIEMENS AKTIENGESELLSCHAFT, Munich (DE)

(72) Inventors: Rüdiger BERTSCH, Erlangen (DE); Thomas FRIESE, Munich (DE); Thomas GOßLER, Erlangen (DE); Michael MARTENS, Weisendorf (DE)

(73) Assignee: SIEMENS AKTIENGESELLSCHAFT, Munich (DE)

(21) Appl. No.: 14/191,821

(22) Filed: Feb. 27, 2014

(30) Foreign Application Priority Data
May 13, 2013 (DE) 102013208762.4

(51) Int. Cl. G06F 3/0481; G06F 3/0484

(52) U.S. Cl. CPC G06F 3/04815; G06F 3/04845
USPC 715/848

(57) ABSTRACT

In an embodiment, the computing unit determines a spherical volume region corresponding to a sphere and lying in front of a display device and the midpoint of the volume region. Furthermore, the computing unit inserts manipulation possibilities related to the output image into image regions of the output image. An image capture device captures a sequence of depth images and communicates it to the computing unit. The computing unit ascertains therefrom whether and, if appropriate, at which of a plurality of image regions the user points with an arm or a hand, whether the user performs a predefined gesture that differs from pointing at the output image or an image region, or whether the user performs a grasping movement with regard to the volume region. Depending on the result of the evaluation, the computing unit may activate a manipulation possibility, perform an action, or rotates the three-dimensional structure.

### PRIORITY STATEMENT

The present application hereby claims priority under 35 U.S.C. §119 to German patent application number DE 102013208762.4 filed May 13, 2013, the entire contents of which are hereby incorporated herein by reference.

### FIELD

At least one embodiment of the present invention generally relates to a control method for a computing unit,
wherein the computing unit outputs, via a display device, a perspective representation of a three-dimensional structure to a user of the computing unit,
wherein an image capture device captures a sequence of depth images and communicates them to the computing unit.

At least one embodiment of the present invention furthermore generally relates to a control method for a computing unit,
wherein the computing unit outputs via a display device at least one image of a structure to a user of the computing unit,
wherein an image capture device captures a sequence of depth images and communicates it to the computing unit,
wherein the computing unit ascertains on the basis of the sequence of depth images whether and, if appropriate, at which of a plurality of image regions of the image the user points with an arm or a hand.

At least one embodiment of the present invention furthermore generally relates to a control method for a computing unit,
wherein the computing unit outputs via a display device at least one image of a structure to a user of the computing unit,
wherein an image capture device captures a sequence of depth images and communicates it to the computing unit.

At least one embodiment of the present invention furthermore generally relates to a computer device,
wherein the computer device comprises an image capture device, a display device and a computing unit,
wherein the computing unit is connected to the image capture device and the display device for the purpose of exchanging data,
wherein the computing unit, the image capture device and the display device interact with one another in accordance with at least one control method of the type described above.

### BACKGROUND

Control methods and computer devices are known. Purely by way of example, reference is made to the Kinect system from Microsoft.

Contactless interaction with computer devices is a distinct trend in the context of so-called natural input methods (NUI—Natural User Input). This applies both in information processing generally and in particular in the medical field. In this regard, contactless interaction is used in operating rooms, for example, in which the operating surgeon would like to view operation-related images of the patient during the operation. In this case, the operating surgeon is not permitted to touch conventional interaction devices of the computer device (for example a computer mouse, a keyboard or a touchscreen), for reasons of sterility. Nevertheless, it must be possible to control the display device. In particular, it must be possible to control what image is represented on the display device and how it is represented. In general, it must furthermore be possible to operate buttons and the like represented on the display device.

It is known for a person other than the operating surgeon to operate the conventional interaction devices on the basis of corresponding instructions by the surgeon. This is laborious, costs valuable time and often leads to communication problems between the operating surgeon and the other person. The known gesture control explained above constitutes a valuable advantage here since the treating surgeon himself/herself can communicate with the computing device without having to touch any devices of the computing device.

In the case of gesture control, generally a so-called depth image is ascertained, i.e. an image in which every point of an inherently two-dimensional image is additionally assigned information about the third direction in three-dimensional space. The capture and evaluation of such depth images is known per se. Such depth images can be captured by means of two conventional cameras, for example, which together yield a stereoscopic image. Alternatively, it is possible, for example, to project a sinusoidally modulated pattern into the space and to ascertain the depth information on the basis of distortions of the sinusoidally modulated pattern.

Particularly in the medical environment, a simple and reliable interaction is of importance—independently of whether it is carried out by way of gesture control or in some other way.

In the case of surgical interventions, the trend for many years has been more and more in the direction of minimally invasive interventions. That is to say that only a small cut is made, via which the surgical instruments are inserted into the patient's body. Therefore, the surgeon does not see the site where he/she is operating with the respective surgical instrument directly with his/her eyes. Rather—for example by means of X-ray technology—an image is captured and displayed to the surgeon via the display device. Furthermore, frequently images are also created in the context of preparing for the operation. This can involve individual two-dimensional images, three-dimensional volume data sets and sequences of images, wherein the sequences succeed one another spatially (in this case usually in the third dimension orthogonal to the images) and/or temporally. Such images, volume data sets and sequences are also frequently required and evaluated in the context of operations.

In the case of volume data sets, the latter very generally show a three-dimensional structure, for example a blood vessel system. Such three-dimensional structures are often output to the user in a perspective representation via the display device. Such representations often have to be rotated and turned in practice since—depending on the rotational position—specific details of the three-dimensional structure are visible or concealed. The parameters of the rotation, that is to say in particular a rotation angle and a rotation axis, are generally stipulated for the computing unit by the user of the computing unit.

In the prior art, the stipulation is generally carried out by means of a computer mouse, a keyboard or a touchscreen. In the context of gesture control, the stipulation is usually carried out by a swipe-like movement of the user being converted into a rotation about a rotation axis orthogonal to the swipe-like movement. This procedure is not intuitive for the user in particular because a purely two-dimensional movement (namely the swipe-like movement) is converted into a three-dimensional movement (namely the rotational movement of the structure).

### SUMMARY

At least one embodiment of the present invention provides possibilities which make available to the user an intuitive possibility of bringing about a rotation of a three-dimensional structure represented via the display device.

A control method is disclosed. Dependent claims relate to advantageous configurations of the control method according to embodiments of the invention.

According to at least one embodiment of the invention, a control method for a computing unit,
wherein the computing unit outputs, via a display device, a perspective representation of a three-dimensional structure to a user of the computing unit, and
wherein an image capture device captures a sequence of depth images and communicates them to the computing unit, and
   is configured
in that the computing unit defines a sphere, the midpoint of which lies within the three-dimensional structure,
in that a spherical volume region corresponding to the sphere and lying in front of the display device and the midpoint of said volume region are determined by the computing unit, and
in that the computing unit ascertains, on the basis of the sequence of depth images, whether the user performs a grasping movement with regard to the volume region and, depending on the grasping movement, varies the perspective representation of the three-dimensional structure output via the display device in such a way that the three-dimensional structure rotates about a rotation axis containing the midpoint of the sphere.

According to an embodiment of the invention, a control method for a computing unit,
wherein the computing unit outputs via a display device at least one image of a structure to a user of the computing unit,
wherein an image capture device captures a sequence of depth images and communicates it to the computing unit, and
wherein the computing unit ascertains on the basis of the sequence of depth images whether and, if appropriate, at which of a plurality of image regions of the image the user points with an arm or a hand,
   is configured
in that manipulation possibilities related to the output image are inserted into image regions of the output image by the computing unit on the basis of a user command, and
in that the computing unit activates, if appropriate, that manipulation possibility in the output image which corresponds to the image region at which the user points.

According to an embodiment of the invention, a control method for a computing unit,
wherein the computing unit outputs via a display device at least one image of a structure to a user of the computing unit, and
wherein an image capture device captures a sequence of depth images and communicates it to the computing unit,
   is configured
in that the computing unit ascertains on the basis of the sequence of depth images whether the user performs a predefined gesture that differs from pointing at the output image or an image region of the output image,
in that an action is performed by the computing unit in the case where the user performs the predefined gesture, and
in that the action is an action that differs from a manipulation of the output image.

Embodiments of the invention further relate to a computer device in which the computing unit, the image capture device and the display device interact with one another in accordance with a control method as disclosed in at least one of the above embodiments.

### BRIEF DESCRIPTION OF THE DRAWINGS

The above-described properties, features and advantages of this invention and the way in which they are achieved will become clearer and more clearly understood in association with the following description of the example embodiments explained in greater detail in conjunction with the drawings, in which, in schematic illustration:

FIG. 1 shows a computer device,

FIG. 2 shows a flowchart,

FIG. 3 shows an image represented by means of a display device,

FIG. 4 shows a flowchart,

FIG. 5 shows a modification of the image from FIG. 2,

FIG. 6 shows a flowchart,

FIG. 7 shows a modification of the image from FIG. 2,

FIG. 8 shows a plurality of images represented by means of the display device,

FIG. 9 shows a flowchart,

FIG. 10 shows a modification of the image from FIG. 2,

FIGS. 11 and 12 show flowcharts and

FIGS. 13 and 14 each show a hand and a volume region.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

According to at least one embodiment of the invention, a control method for a computing unit,
wherein the computing unit outputs, via a display device, a perspective representation of a three-dimensional structure to a user of the computing unit, and
wherein an image capture device captures a sequence of depth images and communicates them to the computing unit, and
   is configured
in that the computing unit defines a sphere, the midpoint of which lies within the three-dimensional structure,
in that a spherical volume region corresponding to the sphere and lying in front of the display device and the midpoint of said volume region are determined by the computing unit, and
in that the computing unit ascertains, on the basis of the sequence of depth images, whether the user performs a grasping movement with regard to the volume region and, depending on the grasping movement, varies the perspective representation of the three-dimensional structure output via the display device in such a way that the three-dimensional structure rotates about a rotation axis containing the midpoint of the sphere.

In the very simplest case, the dependence on the grasping movement resides in the fact that the grasping movement as such initiates the variation of the perspective representation and a release terminates the variation of the perspective representation. For the user, therefore, the representation of the three-dimensional structure behaves, for example, as if said user held the sphere in the hand and rotated the sphere in said user's hand.

It is possible for the rotation axis to be predetermined. In this case, the rotation axis can be oriented horizontally or vertically, for example. Alternatively, it is possible for the rotation axis to be determined by the computing unit on the basis of the grasping movement. If the user grasps the volume region corresponding to the sphere with the fingers of a hand, the computing unit can, in accordance with a best-fit algorithm, for example, determine that circle on the surface of the volume region which is at the smallest distance from the fingers of the hand. In this case, the rotation axis can run orthogonally to the circle. It is in turn possible for the rotation axis to be stipulated for the computing unit by the user by means of a stipulation that differs from the grasping movement. Any arbitrary stipulation in principle is possible here.

Alternatively, it is possible that the computing unit
on the basis of the sequence of depth images ascertains grasping and release of the volume region with the fingers of at least one hand of the user and changes made after the grasping of the volume region regarding the orientation of the at least one finger of the user relative to the midpoint of the volume region,
upon the grasping of the volume region ascertains an orientation existing upon the grasping of the volume region regarding at least one finger of the user relative to the midpoint of the volume region,
on the basis of the changes made after the grasping of the volume region regarding the orientation of the at least one finger of the user, varies the perspective representation of the three-dimensional structure that is output via the display device in such a way that the rotation of the three-dimensional structure about the midpoint of the sphere corresponds to the changes made after the grasping of the volume region regarding the orientation of the at least one finger of the user, and
terminates the variation of the perspective representation upon the release of the volume region.

One possible configuration of this procedure resides in the fact that the computing unit ascertains grasping and release of the volume region by identifying grasping and release of the volume region as a whole on the basis of the sequence of depth images, and that the computing unit ascertains changes regarding the orientation of the at least one finger of the user as a result of a rotation of the at least one hand of the user as a whole.

This procedure is particularly intuitive because the user can virtually rotate in his/her hand (or in his/her hands) the volume region grasped by said user and the rotation of the three-dimensional structure corresponds 1:1 to the rotation of the hands of said user as performed by the latter. With sufficiently reliable identification of grasping and release, it is even possible that the user gasps the volume region with one of his/her hands, rotates it a little, then grasps it with his/her other hand and only then releases it with his/her first hand and continues to rotate it with the other hand. Alternatively, it is possible that the user releases the volume region, rotates the grasping hand backward (the three-dimensional structure is not concomitantly rotated in the process) and then grasps the volume region again and rotates it further.

A further possible configuration of this procedure resides in the fact that the computing unit ascertains grasping and release of the volume region by identifying touching and release of a point of the surface of the volume region on the basis of the sequence of depth images, and that the computing unit ascertains changes regarding the orientation of the at least one finger on the basis of changes regarding the position of the at least one finger on the surface of the volume region. The user can grasp the sphere, for example, as if there were a knob or handle on the sphere, and can rotate the sphere by rotating the knob or handle about the midpoint of the sphere. Alternatively, for example in the same way that in reality one can place a finger onto a globe and can rotate the globe by moving the finger, the user can also place just a finger onto the surface of the volume region and move the finger.

The last-mentioned procedure can be configured even further under certain circumstances. In particular, it is possible that the computing unit after the grasping of the volume region, on the basis of the sequence of depth images, additionally ascertains whether the user with the at least one finger of the at least one hand performs a movement toward and away from the midpoint of the volume region, and that the computing unit varies a scaling factor, used by said computing unit when ascertaining the representation, in a manner dependent on the movement of the finger toward and away from the midpoint of the volume region. As a result, zooming can also be implemented in addition to the rotation.

In practice, slight movements toward and away from the midpoint of the volume region cannot be avoided. In order nevertheless to ensure a stable representation of the three-dimensional structure, it is possible that the computing unit performs the zooming only if the movement toward and away from the midpoint of the volume region is significant. By way of example, in the case where the movement toward and away from the midpoint of the volume region is performed simultaneously with the change regarding the orientation of the at least one finger, the computing unit can suppress the zooming if—relative to the length of the path traveled on the surface of the volume region—the movement toward and away from the midpoint of the volume region remains below a predetermined percentage. Independently of a change regarding the orientation of the at least one finger—that is to say in any case—it is possible that the computing unit suppresses the zooming if the movement toward and away from the midpoint of the volume region, relative to the original or instantaneous distance between the finger and the midpoint of the volume region, remains below a predetermined percentage.

In a further preferred configuration it is provided that the computing unit inserts into the perspective representation of the three-dimensional structure the midpoint of the sphere and a grid arranged on a surface of the sphere. As a result, for the user firstly it is discernible that the user is actually in that mode in which rotation of the three-dimensional structure is performed. Furthermore, detection of the rotational movement is possible in a particularly simple manner for the user. The advantages mentioned can be reinforced even further by virtue of the fact that the computing unit additionally inserts the rotation axis into the perspective representation of the three-dimensional structure.

The rotation of a three-dimensional structure about a rotation axis is one manipulation possibility for a represented image. This manipulation possibility is provided especially in the case of three-dimensional structures. Independently of whether the represented image (which is two-dimensional as such) is a perspective representation of a three-dimensional structure or is (for example) a slice image of a three-dimensional data set or whether the represented image is already based on an image which is two-dimensional as such (example: an individual radiograph), a plurality of different manipulation possibilities are generally provided, however, with regard to the represented image. In this regard, by way of example, the scaling factor (zoom factor) can be set. In the case where only a part of a two-dimensional image is output, the image region, for example, can be selected, for example by corresponding panning. It is also possible to vary the contrast ratios (windowing). Other manipulation possibilities are also possible, for example switching from partial image to full image (blow up) or scrolling through a sequence of spatially or temporally successive images. A sequence of spatially successive images is a sequence of slice images, for example. A sequence of temporally successive images is an angiography scene, for example.

The various manipulation possibilities must be activatable by the user in a simple and reliable manner. Conventional buttons on screens (soft buttons) are suitable only to a limited extent for such switching in the case of gesture control, because the region at which the user points can be ascertained only relatively roughly by the computing unit, such as a device including a processor for example, in the case of gesture control. Furthermore, a plurality of mouse buttons are not available in the case of gesture control, for example in contrast to the operation of a computer mouse.

A second embodiment of the present invention provides possibilities which make available to the user an easily handleable possibility for being able to activate different image-related manipulation possibilities.

A control method is disclosed in at least one embodiment. Dependent claims relate to advantageous configurations of the control method according to the invention.

According to an embodiment of the invention, a control method for a computing unit,
wherein the computing unit outputs via a display device at least one image of a structure to a user of the computing unit,
wherein an image capture device captures a sequence of depth images and communicates it to the computing unit, and
wherein the computing unit ascertains on the basis of the sequence of depth images whether and, if appropriate, at which of a plurality of image regions of the image the user points with an arm or a hand,
   is configured
in that manipulation possibilities related to the output image are inserted into image regions of the output image by the computing unit on the basis of a user command, and
in that the computing unit activates, if appropriate, that manipulation possibility in the output image which corresponds to the image region at which the user points.

By virtue of the fact that the manipulation possibilities are inserted into image regions of the output image itself, in contrast to the prior art large-area buttons—namely the image regions—are available, which can be distinguished from one another in a simple manner by the computing unit even in the case of gesture control.

Preferably, the image regions cover the entire output image in their entirety. As a result, the size of the buttons can be maximized.

Preferably, the manipulation possibilities are inserted into the output image in a semitransparent manner by the computing unit. As a result, the output image as such remains visible and discernible. As a result, the certainty with which the user activates the manipulation possibility actually desired by said user can be increased.

Furthermore, it is preferred that the computing unit, before inserting the manipulation possibilities into the output image, ascertains from a totality of manipulation possibilities implementable in principle those manipulation possibilities which are implementable with regard to the output image, and that the computing unit inserts exclusively the implementable manipulation possibilities into the output image. As a result, the number of manipulation possibilities inserted into the output image can be minimized, such that conversely in turn larger buttons are available for the individual manipulation possibilities.

Preferably, the image regions which adjoin one another are inserted into the output image in mutually different colors and/or mutually different brightnesses. As a result, the individual image regions can be distinguished from one another rapidly and easily by the user.

It is possible that at a specific point in time the computing unit outputs only a single image to the user via the display device. Alternatively, it is possible that the computing unit outputs via the display device, in addition to the image of the structure, at least one further image of the structure and/or a further image of a different structure to the user of the computing unit.

In this case, one advantageous configuration of an embodiment of the present invention resides
in that manipulation possibilities related to the further image are also inserted into image regions of the further image by the computing unit on the basis of the user command,

in that the computing unit ascertains on the basis of the sequence of depth images whether and, if appropriate, at which of the image regions of the further image the user points with the arm or the hand, and
in that the computing unit activates, if appropriate, the manipulation possibility—corresponding to the image region at which the user points—in that image in which the relevant image region is arranged.

This procedure provides a simultaneous selection both of one of the images and of the manipulation possibility which is to be activated with regard to the selected image. The preferred configurations explained above in the case of inserting the manipulation possibilities are preferably implemented by the computing unit with regard to the further image as well.

In addition to manipulations of images, there are also other, rather global system interactions of the user which are not related to a specific image region or a specific view of an image. Examples of such system interactions include loading a data set of a specific patient (wherein the data set of said patient can contain a multiplicity of two-dimensional and three-dimensional images) or for example—in contrast to scrolling, in the course of which, in a sequence of images, the image selected is always the one that precedes or succeeds the currently selected image—jumping to a specific image, for example to the first or last image of the sequence.

A third embodiment of the present invention resides in providing possibilities which make available to the user an easily handleable possibility for being able to perform rather global system interactions.

The third embodiment is achieved by a control method. Dependent claims relate to advantageous configurations of the control method according to the invention.

According to an embodiment of the invention, a control method for a computing unit,
wherein the computing unit outputs via a display device at least one image of a structure to a user of the computing unit, and
wherein an image capture device captures a sequence of depth images and communicates it to the computing unit,
   is configured
in that the computing unit ascertains on the basis of the sequence of depth images whether the user performs a predefined gesture that differs from pointing at the output image or an image region of the output image,
in that an action is performed by the computing unit in the case where the user performs the predefined gesture, and
in that the action is an action that differs from a manipulation of the output image.

As a result, other, non-image-related actions can also be performed in a simple manner. The gestures can be determined as required. By way of example, using a specific part of the body (in particular the hand) the user can perform a circular movement or a movement similar to a number—for example the number 8—or waving. Other gestures are also possible.

The action as such can be determined as required. In particular, it is possible that the action is transferring the computing unit into a state, and that the state is independent of the output image or is the same for the output image and at least one further image which can be output as an alternative to the output image. Precisely by means of such actions it is possible to realize global system interactions of the user which are not related to a specific image region or a specific view of an image.

In one example configuration of the control method according to an embodiment of the invention, it is provided that the state is calling up a selection menu having a plurality of menu items, and that the menu items can be chosen by the user by pointing at the respective menu item. As a result, it is possible to realize, in particular, simple navigation in a—in particular multiply stepped—menu tree.

It is preferred for the selection menu to be inserted into the output image by the computing unit. In particular, the selection menu can be inserted into the output image in a semitransparent manner by the computing unit.

In experiments it has proved to be advantageous that the selection menu is inserted into the output image as a circle by the computing unit, and that the menu items are represented as sectors of the circle.

It is furthermore preferred that the computing unit waits for a confirmation by the user after one of the menu items has been chosen, and that the chosen menu item is implemented by the computing unit only following stipulation of the confirmation by the user. As a result, an inadvertent selection of a menu item not actually intended can be avoided.

The confirmation can be determined as required. By way of example, the confirmation can be embodied as stipulation of a predetermined gesture by the user, as a command of the user that differs from a gesture, or as the elapsing of a waiting time.

Embodiments of the invention further relate to a computer device in which the computing unit, the image capture device and the display device interact with one another in accordance with a control method as disclosed in at least one of the above embodiments.

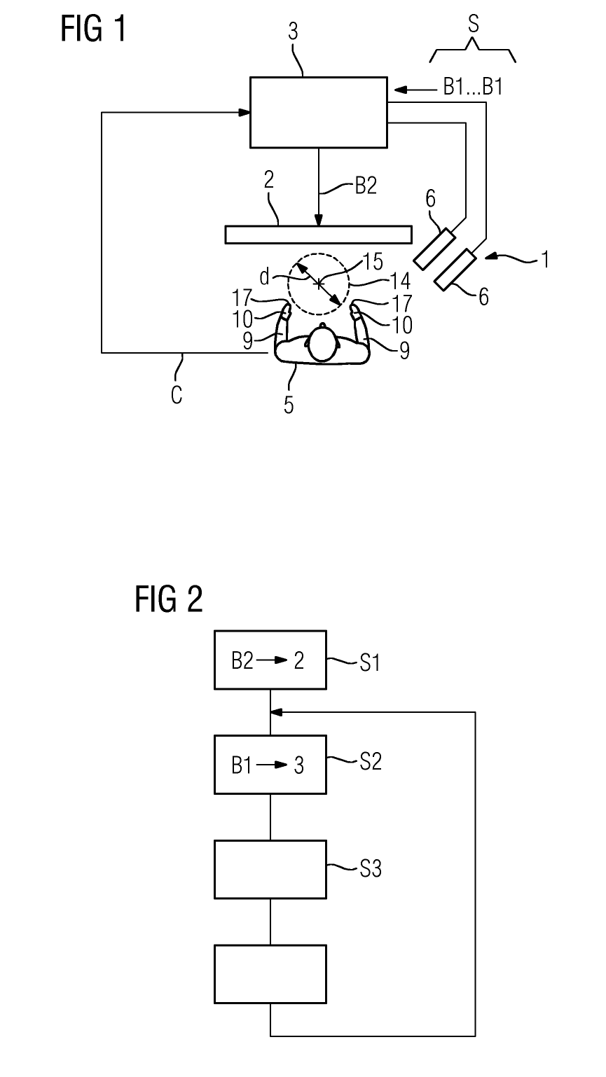

In accordance with FIG. 1, a computer device comprises an image capture device 1, a display device 2 and a computing unit 3. The image capture device 1 and the display device 2 are connected to the computing unit 3 for the purpose of exchanging data. In particular, the image capture device 1 captures a sequence S of depth images B1 and communicates it to the computing unit 3. The depth images B1 captured by the image capture device 1 are evaluated by the computing unit 3. Depending on the result of the evaluation, a suitable reaction can be implemented by the computing unit 3.

The computing unit 3 can be embodied, for example, as a conventional PC, as a workstation or similar computing unit. The display device 2 can be embodied as a conventional computer display, for example as an LCD display or as a TFT display.

The image capture device 1, the display device 2 and the computing unit 3 interact as follows in accordance with FIG. 2:

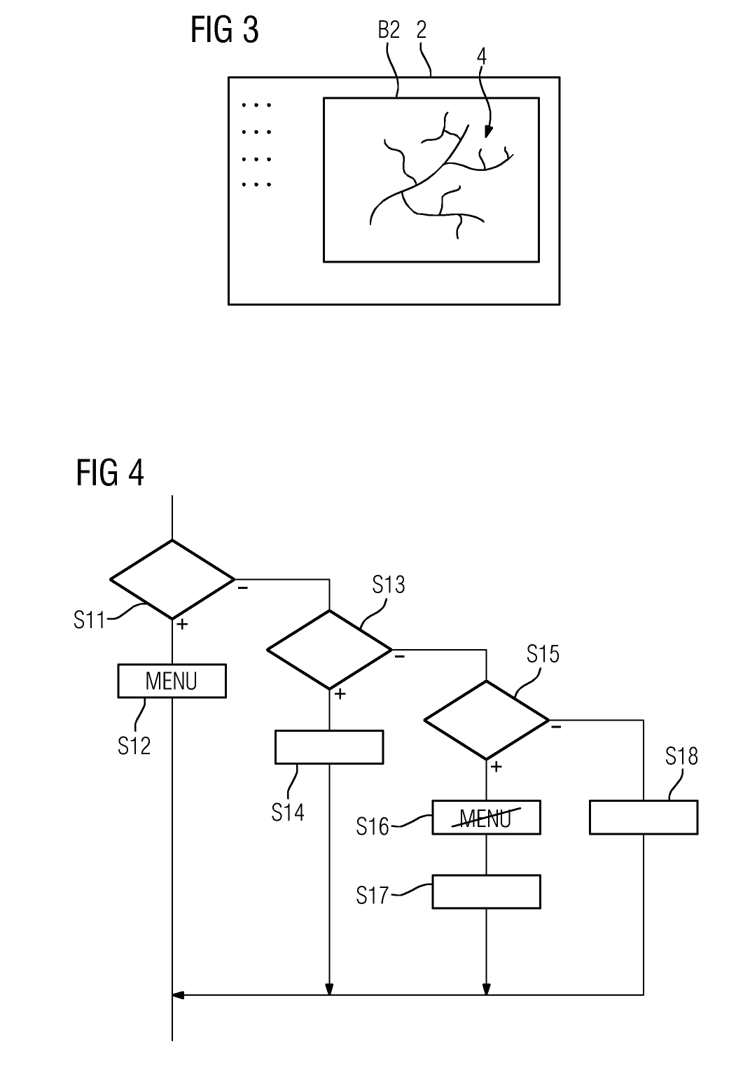

In a step S1, the computing unit 3 outputs via the display device 2 an (at least one) image B2 of a structure 4 to a user 5 of the computing unit 3 (see FIG. 3). The structure 4 can be a vascular tree of a patient—for example—in accordance with the illustration in FIG. 3. The structure 4 can be a three-dimensional structure which is output in a perspective representation. This is not absolutely necessary, however.

The image capture device 1 continuously captures a respective depth image B1 and communicates it to the computing unit 3. The computing unit 3 receives the respectively captured depth image B1 in a step S2.

A depth image B1 is, as is known to those skilled in the art, a two-dimensionally spatially resolved image in which the individual pixels of the depth image B1—if appropriate in addition to their image data value—are assigned a depth value that is characteristic of a distance from the image capture device 1, said distance being assigned to the respective pixel. The capture of such depth images B1 is known as such to those skilled in the art. By way of example, the image capture device 1, in accordance with the illustration in FIG. 1, can comprise a plurality of individual image sensors 6 which capture the captured scene from different viewing directions. Alternatively, it is possible, for example, by means of a suitable luminous source, to project a stripe pattern (or some other pattern) into the space captured by the image capture device 1 and to ascertain the respective distance on the basis of distortions of the pattern in the depth image B1 captured by the image capture device 1.

Owing to the circumstance that the depth images B1 enable a three-dimensional evaluation, in particular a reliable evaluation of the depth image B1 by the computing unit 3—i.e. a reliable identification of the respective gestures of the user 5—is possible. For clear identification of the gestures, special markings can be arranged on the user 5. By way of example, the user 5 can wear special gloves. However, this is not absolutely necessary. The computing unit 3 performs the evaluation in a step S3.

In a step S4, the computing unit 3 reacts according to the evaluation performed in step S3. The reaction can be of any arbitrary nature. Inter alia, the reaction can (but need not) consist in a variation of the driving of the display device 2. The computing unit 3 then returns to step S2, such that the sequence of steps S2, S3 and S4 is repeatedly iterated. In the course of the repeated performance of steps S2, S3 and S4, the image capture device 1 thus captures the sequence S of depth images B1 and communicates it to the computing unit 3.

FIG. 4 shows one possible procedure for evaluation and corresponding reaction. FIG. 4 therefore shows one possible implementation of steps S3 and S4 from FIG. 2.

In accordance with FIG. 4, in a step S11 the computing unit 3 ascertains on the basis of the sequence S of depth images B1 whether the user 5 performs a predefined gesture. The gesture can be defined as required. However, it differs from pointing at the output image B2. In particular, a part of the image B2 (image region) is not pointed at either. By way of example, the computing unit 3 can check, by evaluating the sequence S of depth images B1, whether the user 5 raises one hand or both hands, whether the user 5 claps the hands once or twice, whether the user 5 waves with one or both hands, the user 5 draws a numeral—in particular the numeral 8—in the air with one hand, and suchlike. Depending on the result of the check in step S11, the computing unit 3 undergoes transition to a step S12 or to a step S13. The computing unit 3 undergoes transition to step S12 if the user 5 has performed the predefined gesture. The computing unit 3 undergoes transition to step S13 if the user 5 has not performed the predefined gesture.

In step S12, the computing unit 3 performs an action. The action can be determined as required. In any case, however, it is an action that differs from a manipulation of the output image B2. In particular, the action can consist in the fact that the computing unit 3 is transferred into a state, wherein the state is independent of the image B2 output via the display device 2. Alternatively, it is possible that a multiplicity of mutually different images B2 can be output via the display device 2 and that the state is the same in each case for groups of a plurality of such images B2. It is therefore possible, for example, that the computing unit 3 is always transferred into a first state if an arbitrary image B2 of a first group of images B2 that can be output is output to the user 5 via the display device 2. By contrast, the computing unit 3 is always transferred into a second state, which differs from the first state, if an arbitrary image B2 of a second group of images B2 that can be output is output via the display device 2.

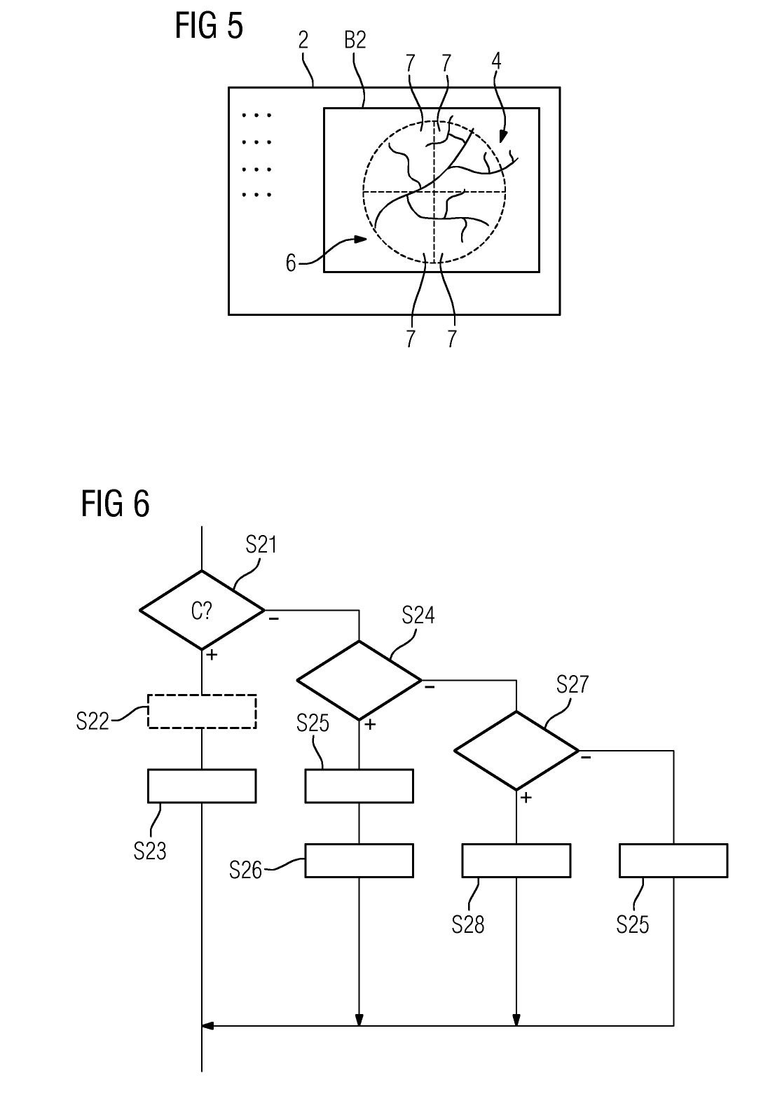

In particular, it is possible that the state is calling up a selection menu 6, in accordance with the illustration in FIGS. 4 and 5. The selection menu 6 has a plurality of menu items 7.

It is possible that, instead of the output image B2, the selection menu 6 is output to the user 5 via the display device 2. Preferably, however, the selection menu 6 is inserted into the output image B2 by the computing unit 3 in accordance with the illustration in FIG. 5. The insertion can be semitransparent, in particular, in accordance with the dashed illustration in FIG. 5, such that the user 5 can identify both the output image B2 and the selection menu 6.

The representation of the selection menu 6 can be as required. Preferably, in accordance with FIG. 5, the selection menu 6 is inserted into the output image B2 as a circle by the computing unit 3. The menu items 7 are preferably represented as sectors of the circle.

The menu items 7 can be chosen by the user 5 by pointing at the respective menu item 7. In step S13, the computing unit 3 checks, by evaluating the sequence S of depth images B1, whether the user 5 points at one of the menu items 7 represented. The check in step S13 also comprises, in particular, the check of whether step S12 has already been performed at all, that is to say that the selection menu 6 is output to the user 5 via the display device 2. Depending on the result of the check, the computing unit 3 undergoes transition to a step S14 or to a step S15. The computing unit 3 undergoes transition to the step S14 if the user 5 points at one of the menu items 7 represented. The computing unit 3 undergoes transition to step S15 if the user 5 does not point at one of the menu items 7 represented.

In step S14, the computing unit 3 marks, in the selection menu 6 displayed, that menu item 7 at which the user has pointed. By contrast, a further-reaching reaction is not yet performed. Therefore, although pointing at the corresponding menu item 7 on the part of the user 5 corresponds to a preselection, it does not yet correspond to a final selection.

In step S15, the computing unit 3 waits to determine whether a confirmation is stipulated for it by the user 5. The check in step S15 also comprises, in particular, the check of whether steps S12 and S14 have already been performed at all, that is to say that the user 5 has selected a menu item 7. Depending on the result of the check, the computing unit 3 undergoes transition to steps S16 and S17 or to a step S18. The computing unit 3 undergoes transition to steps S16 and S17 if the user 5 stipulates the confirmation for the computing unit 3. The computing unit 3 undergoes transition to step S18 as long as the user 5 does not stipulate the confirmation.

In step S16, the computing unit 3 deletes the selection menu 6 output via the display device 2. The selection menu 6 is therefore no longer inserted into the output image B2 or displayed instead of the output image B2. In step S17, the computing unit 3 performs the menu item 7 (now finally) chosen. In step S18, by contrast, the computing unit 3 performs a different reaction. The different reaction can consist, under certain circumstances, simply in further waiting.

The confirmation awaited by the computing unit 3 from the user 5 can be determined as required. By way of example, the confirmation can be embodied as a stipulation of a predetermined gesture by the user 5. By way of example, it can be demanded that the user 5 claps hands once or twice. Other gestures are also possible. By way of example, the user 5 may have to perform a grasping gesture with the hand 10 or may have to successively move the hand 10 firstly away from the display device 2 and then toward the display device 2 again. The opposite order is also possible. Alternatively or additionally, it is possible for the user 5 to stipulate for the computing unit 3 a command that differs from a gesture, for example a voice command or the actuation of a foot-operated switch or a foot-operated button. Furthermore, it is possible for the confirmation to consist in waiting for a waiting time to elapse. The waiting time varies, if appropriate, in the range of a few seconds, for example a minimum of 2 seconds and a maximum of 5 seconds.

Further possible configurations in the context of the gesture control of the computing unit 3 by the user 5 are explained below in conjunction with FIGS. 6 to 8. These configurations concern manipulations of the image B2 output via the display device 2. These configurations likewise assume at least from the computer device in accordance with FIG. 1 the manner of operation thereof in accordance with FIG. 2. In this case, FIG. 6 shows one possible configuration of steps S3 and S4 from FIG. 2. It is alternatively possible for the procedures in FIGS. 6 to 8 to be based on the procedures in FIGS. 3 to 5. In this case, FIG. 6 shows one possible configuration of step S18 from FIG. 4.

In the case of the procedure in accordance with FIG. 6, therefore, it is assumed that the computing unit 3 outputs via the display device 2 at least one image B2 of the structure 4 to the user 5 of the computing unit 3. It is furthermore assumed that the image capture device 1 captures a sequence S of depth images B1 and communicates it to the computing unit 3. This has already been explained above in conjunction with FIGS. 1 and 2.

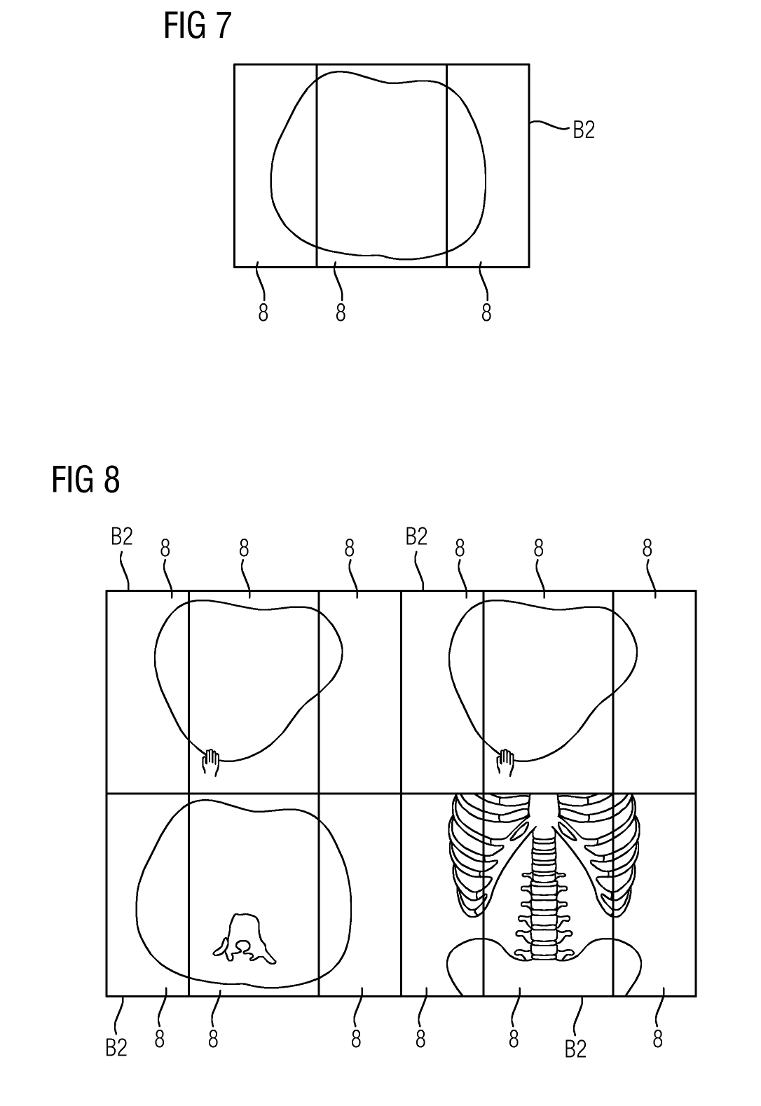

In accordance with FIG. 6, in a step S21, the computing unit 3 checks whether a user command C is stipulated for it by the user 5, in accordance with which command manipulation possibilities in the output image B2 are intended to be inserted into image regions 8 of the output image B2 (see FIG. 7). The user command C can be stipulated for the computing unit 3 by the user 5 by a gesture identified on the basis of the sequence S of depth images B1, or in some other way, for example by a voice command.

If the user 5 stipulates the user command C, the computing unit 3 undergoes transition to the yes branch of step S21. In the yes branch of step S21, the computing unit 3 preferably performs a step S22, but in any case a step S23. In step S23, the computing unit 3 inserts manipulation possibilities related to the output image B2 into the image regions 8 in accordance with the illustration in FIG. 7. The manipulation possibilities can concern, for example, setting a scaling factor, selecting an image excerpt to be output, or setting contrast properties. There are also other manipulation possibilities.

If step S22 is not present, in step S23 all manipulation possibilities that can be implemented in principle with regard to output images B2, that is to say the totality of said manipulation possibilities, are inserted into the image regions 8. In general, however, some of the manipulation possibilities are not possible or are impermissible with regard to the image B2 specifically output. By way of example, the rotation of a structure 4 is only expedient if the structure 4 is three-dimensional. If the output image B2 is based on a two-dimensional structure 4, therefore, rotation is not possible. The selection of an image excerpt to be output by panning is expedient, for example, only if a part of the image is output, that is to say that a selection is possible at all. If step S22 is present, the computing unit 3 firstly ascertains, from the totality of manipulation possibilities that can be implemented in principle, those manipulation possibilities which can be implemented with regard to the output image B2. In this case, in step S23, exclusively the implementable manipulation possibilities are inserted into the output image B2.

In the no branch of step S21, the computing unit 3 firstly performs a step S24. In step S24, the computing unit 3 checks, by evaluating the sequence S of depth images B1, whether the user 5 points at one of the image regions 8 with an arm or a hand 10. If appropriate, in the context of step S24, by evaluating the sequence S of depth images B1, the computing unit 3 also ascertains which of the image regions 8 the user 5 points at. The check in step S24 also comprises, inter alia, the check of whether the user command C was already stipulated (earlier), that is to say that the manipulation possibilities have been inserted into the output image B2 at all.

If the computing unit 3 identifies pointing at one of the image regions 8 in step S24, it undergoes transition to steps S25 and S26. In step S25, the manipulation possibilities inserted in step S23 are removed again from the output image B2 by the computing unit 3. In step S26, the computing unit 3 activates the manipulation possibility selected in step S24, that is to say that manipulation possibility at whose corresponding image region 8 the user 5 pointed.

The image regions 8 can be dimensioned as required. Preferably, they cover the entire output image B2 in their entirety in accordance with the illustration in FIG. 7. Furthermore, the manipulation possibilities are preferably inserted into the output image B2 in a semitransparent manner in accordance with the illustration in FIG. 7. For the user 5, therefore, simultaneously both the output image B2 and the manipulation possibilities are visible and discernible. For clear delimitation of the image regions 8 from one another, furthermore, in accordance with the illustration in FIG. 7, preferably mutually adjoining image regions 8 are inserted into the output image B2 in mutually different colors and/or mutually different brightnesses.

If the computing unit 3 does not identify pointing at one of the image regions 8 in step S24, it undergoes transition to a step S27. In step S27, the computing unit 3 checks, by evaluating the sequence S of depth images B1, whether an action in accordance with the selected manipulation possibility has been stipulated for it by the user 5 by gesture control. If this is the case, the computing unit 3 performs the stipulated action in a step S28. Otherwise, the computing unit 3 undergoes transition to a step S29, in which it performs a different reaction. The check in step S27 implies, inter alia, that step S26 has already been performed, that is to say a specific manipulation possibility for the output image B2 has been activated.

The procedures explained above are possible in accordance with FIG. 7 if only a single image B2 is output to the user 5 of the computing unit 3 via the display device 2 at a specific point in time. Alternatively, however, in accordance with the illustration in FIG. 8, it is also possible that, in addition to the image B2 of the structure 4, at least one further image B2 is output to the user 5 of the computing unit 3 via the display device 2 by the computing unit 3. Said further image B2 can be, for example, a different image of the same structure 4. By way of example, one of the images B2 can be a perspective representation of the three-dimensional structure 4, wherein the three-dimensional structure 4 is determined by a three-dimensional data set, while another image B2 (or a plurality of other images B2) show a slice image of the three-dimensional data set. Alternatively, an image of a different structure 4 can be involved. By way of example, one of the images B2 as before can be a perspective representation of the three-dimensional structure 4, while another image B2 (or a plurality of other images B2) show angiography evaluations.

In accordance with the illustration in FIG. 8, in the case where a plurality of images B2 are output via the display device 2, in the context of step S23, for each output image B2, in each case the manipulation possibilities related to the respective output image B2 are inserted into the respective image B2. In this case, in the context of step S24, the computing unit 3 not only ascertains which image region 8 the user 5 pointed at. In this case, the computing unit 3 additionally also ascertains the image B2 with regard to which this took place. In this case, therefore, in the context of step S24, the computing unit 3 ascertains firstly the output image B2 at which the user 5 pointed, and in addition within said image B2 the image region 8 at which the user 5 pointed. In the context of step S26, in this case, it is only with regard to the output image B2 at which the user 5 pointed that the manipulation possibility selected in this regard is activated by the computing unit 3.

Preferably, the advantageous configurations explained above are also realized in the case where a plurality of images B2 are simultaneously output to the user 5 via the display device 2. Preferably, for the output images B2 it therefore holds true
that the image regions 8 cover in each case the entire output image B2 in their entirety,
that the manipulation possibilities are inserted into the respectively output image B2 in a semitransparent manner by the computing unit 3,
that step S22 is present and is performed individually for each output image B2, such that, in step S23, exclusively the implementable manipulation possibilities are in each case inserted into each output image B2 by the computing unit 3, and
that the image regions 8 which adjoin one another are inserted into the output image B2 in mutually different colors and/or mutually different brightnesses.

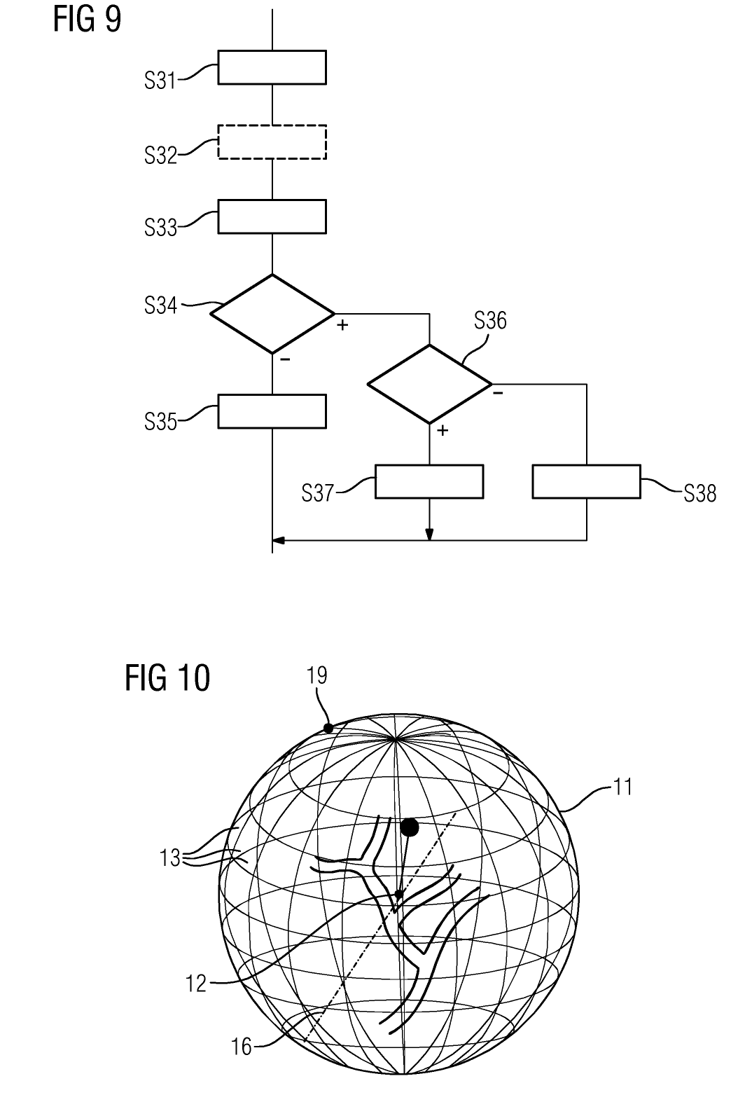

Further possible configurations in the context of the gesture control of the computing unit 3 by the user 5 are explained below in conjunction with FIGS. 9 to 14. These configurations concern manipulations of the image B2 output via the display device 2 most specifically for the case where the image B2 output to the user 5 via the display device 2 by the computing unit 3 is a perspective representation of a three-dimensional structure 4. The procedures explained below in conjunction with FIG. 9 furthermore concern the (virtual) rotation of the represented three-dimensional structure 4, that is to say the corresponding adaptation and variation of the perspective representation of the three-dimensional structure 4 that is output via the display device 2. It is therefore assumed that the computing unit 3 is in a corresponding operating state in which it enables such rotation.

The manner in which the computing unit 3 was put into the corresponding operating state is of secondary importance in the context of FIG. 9. It is possible that the corresponding operating state was assumed fully or partly without the involvement of gesture control. In this case, steps S31 to S38 explained below in conjunction with FIG. 9 are a configuration of steps S3 and S4 from FIG. 2. However, it is likewise possible that the corresponding operating state was already assumed with involvement of gesture control. In this case, steps S31 to S38 explained below in conjunction with FIG. 9 are a configuration of step S18 from FIG. 4 or a configuration of step S29 from FIG. 6.

In the context of the procedure from FIG. 9, the computing unit 3 initiates the rotation in step S31. In particular, in step S31, the computing unit 3 defines a sphere 11 and the midpoint 12 thereof (also see FIG. 10). The sphere 11 is related to the three-dimensional structure 4. In particular, the midpoint 12 of the sphere 11 lies within the three-dimensional structure 4.

Preferably, the computing unit 3, in accordance with the illustration in FIG. 10, in step S32, inserts the midpoint 12 of the sphere 11 into the perspective representation B2 of the three-dimensional structure 4. Furthermore, the computing unit 3, in accordance with the illustration in FIG. 10, in step S32, preferably inserts a grid 13 into the perspective representation B2 of the three-dimensional structure 4, said grid being arranged on the surface of the sphere 11. The grid 13 is preferably (but not necessarily) embodied in a manner similar to geographical degrees of longitude and latitude. However, step S32 is merely optional and therefore illustrated only by dashed lines in FIG. 9.

In step S33, the computing unit 3 determines a volume region 14. The volume region 14 is spherical and has a midpoint 15. In accordance with FIG. 1, the volume region 14 lies in front of the display device 2, in particular between the display device 2 and the user 5. The volume region 14 corresponds to the sphere 11. In particular, the midpoint 15 of the volume region 14 corresponds to the midpoint 12 of the sphere 11 and the surface of the volume region 14 corresponds to the surface of the sphere 11. Gestures performed by the user with regard to the volume region 14 are taken into account by the computing unit 3 in the context of ascertaining the rotation of the three-dimensional structure 4 (more precisely: the variation of the perspective representation B2 of the three-dimensional structure 4 output via the display device 2 in such a way that the three-dimensional structure 4 appears to rotate about a rotation axis 16 containing the midpoint 12 of the sphere 11.

In accordance with FIG. 9, in step S34, the computing unit 3 checks whether it is intended to activate the rotation (or is intended to reactivate said rotation after an interruption). In particular, in step S34, the computing unit 3 checks whether the user 5 performs a grasping movement with regard to the volume region 14. If this is the case, the computing unit 3 undergoes transition to step S35, in which it performs the rotation. In step S35, therefore, the computing unit 3 varies the perspective representation B2 of the three-dimensional structure 4 output via the display device 2 in such a way that the three-dimensional structure 4 rotates about the rotation axis 16. This rotation takes place in a manner dependent on the grasping movement of the user 5, since a transition is made to step S35 only proceeding from step S34.

If the check in step S34 turns out to be negative, that is to say if a grasping movement of the user 5 is not present, the computing unit 3 checks, in step S36, whether the user 5 performs a release movement with regard to the volume region 14. If this is the case, the computing unit 3 undergoes transition to step S37, in which it deactivates, that is to say ends, the rotation. Otherwise, the computing unit 3 undergoes transition to a step S38, in which it performs a different reaction.

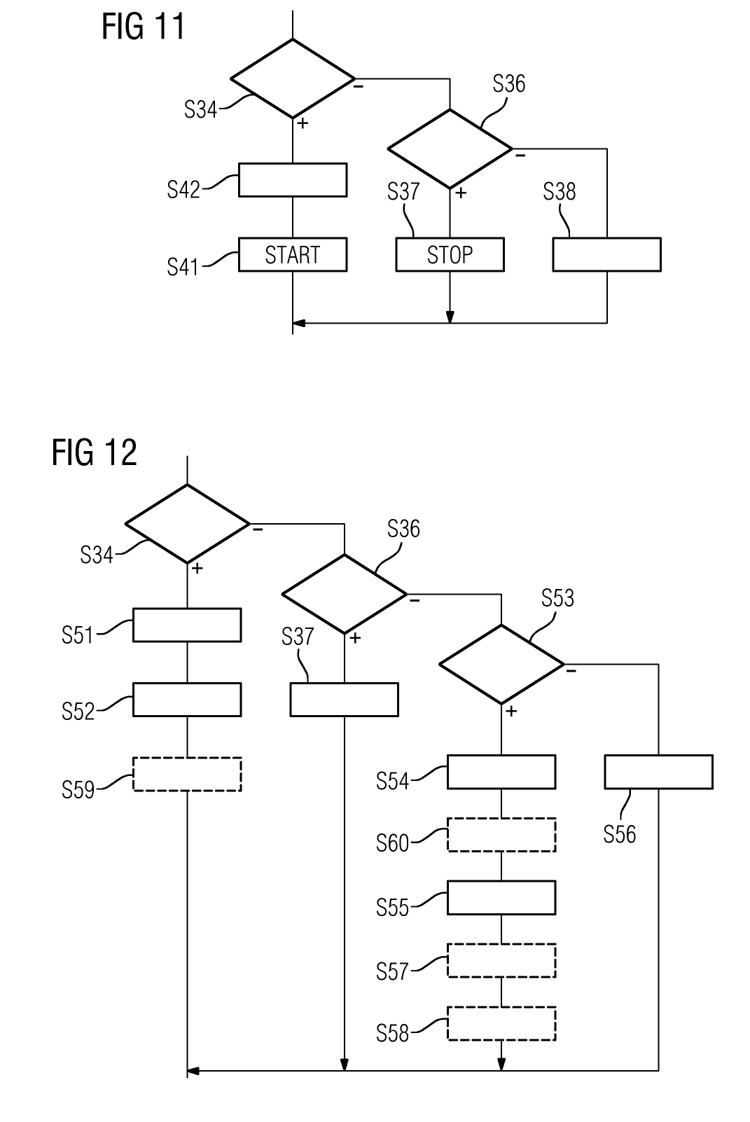

One possible configuration of step S35 from FIG. 9 is explained below in conjunction with FIG. 11.

In the case of the configuration in accordance with FIG. 11, the dependence of the rotation on the grasping movement consists in the fact that the grasping movement as such already initiates the rotation, that is to say the variation of the perspective representation. This is illustrated in a step S41 in FIG. 11. In a manner corresponding thereto, a release terminates the rotation.

In the context of the procedure from FIG. 11, it is possible that the rotation axis 16 is fixedly predetermined beforehand, for example is oriented horizontally or vertically or has a predetermined inclination angle with respect to the vertical. Alternatively, it is possible that the rotation axis 16 is determined by the computing unit 3 on the basis of the grasping movement. By way of example, it is possible that the volume region 14 has a suitable diameter d of, for example, 5 cm to 20 cm (in particular 8 cm to 12 cm) and the user 5 grasps the volume region 14 as a whole with the fingers 17 of a hand 10. In this case, points where the finger 17 touches the surface of the volume region 14 generally form (more or less) a circle. It is possible, for example, that the computing unit 3 determines the touching points and ascertains the corresponding circle on the basis of the touching points. In this case, the rotation axis 16 can be determined, for example, by virtue of the fact that it runs orthogonally to the circle corresponding to said circle on the surface of the sphere 11. However, other procedures are also possible. By way of example, the computing unit 3 can determine an individual touching point in accordance with a predetermined criterion. In this case, by way of example, the rotation axis 16 can be determined by virtue of the fact that it runs orthogonally to a connecting line between that point on the surface of the sphere 11 which corresponds to said touching point and the midpoint 12 of the sphere 11. Alternatively again it is possible that the rotation axis 16 is stipulated for the computing unit 3 by the user 5 by means of some other stipulation that differs from the grasping movement. By way of example, the user 5 can perform a voice input in which the user stipulates the orientation of the rotation axis 16 for the computing unit 3. By way of example, the user 5 can provide the computing unit 3 with the voice stipulation “rotation axis horizontal”, “rotation axis vertical” or “rotation axis oriented at angle XX relative to the vertical” (or horizontal).

Analogously to the midpoint 12 of the sphere 11 and to the grid 13, the rotation axis 16, too, is preferably inserted into the perspective representation B2 of the three-dimensional structure 4 by the computing unit 3. The corresponding step S42 precedes step S41 in this case. However, step S42 is merely optional and, for this reason, is illustrated only by dashed lines in FIG. 11. If the rotation axis 16 is fixedly stipulated for the computing unit 3, in the case of the configuration in accordance with FIG. 11 step S42 can also already be performed in conjunction with step S32.

As an alternative to the procedure explained above in conjunction with FIG. 11, it is possible that the grasping of the volume region indeed activates the rotation of the three-dimensional structure 4, but does not yet directly bring it about. This is explained in greater detail below in conjunction with FIG. 12.

In accordance with FIG. 12, step S34 is likewise present. In step S34, the computing unit 3 checks, on the basis of the sequence S of depth images B1, whether the user 5 grasps the volume region 14 with the fingers 17 of at least one hand 10. Step S34 specifically concerns the grasping movement as such, that is to say the process, but not the state in which the user 5 holds the volume region 14 in his/her grasp.

Instead of step S35, steps S51 and S52 are present in accordance with FIG. 12. If the check in step S34 has a positive outcome, the computing unit 3 firstly undergoes transition to step S51. In step S51, the computing unit 3 activates the rotation of the three-dimensional structure 4, but does not yet carry out rotation. In the context of step S51, it is possible, in particular (inter alia) via the display device 2, also to effect a corresponding indication that the rotation was activated. By way of example, a touching point or the touching points at which the user 5 touches the volume region 14 can be ascertained and the corresponding points of the sphere 11 can be marked. In step S52, the computing unit 3 ascertains an existing orientation of at least one finger 17 of the user 5 relative to the midpoint 15 of the volume region 14. Since step S52 is performed in the yes branch of step S34, the orientation is ascertained by the computing unit 3 upon the grasping of the volume region 14 by the user 5.

If the check in step S34 has a negative outcome, the computing unit 3—as already explained in conjunction with FIG. 9—undergoes transition to step S36. In step S36, the computing unit 3 checks, on the basis of the sequence S of depth images B1, whether the user 5 releases the volume region 14 with the fingers 17 of his/her hand 10. Step S36 concerns—analogously to step S34—specifically the release movement as such, that is to say the process, but not the state, in which the user 5 has released the volume region 14.

If the check in step S36 has a positive outcome, the computing unit 3 undergoes transition to step S37. In step S37, the computing unit 3 terminates the variation of the perspective representation B2. Since step S37 is performed in the yes branch of step S36, the termination takes place upon the release of the volume region 14 by the user 5.

If the check in step S36 has a negative outcome, the computing unit 3 undergoes transition to a step S53. In step S53, the computing unit 3 checks whether the user 5 holds the volume region 14 in his/her grasp. By way of example, the computing unit 3 can set a flag in the context of step S51 and reset the flag in the context of step S37. In this case, the check in step S53 is reduced to an interrogation of the flag. Alternatively, it is possible for the computing unit 3 to ascertain the check in step S53 on the basis of the sequence S of depth images B1 as such.

If the check in step S53 has a positive outcome, the computing unit 3 undergoes transition to a step S54. In step S54, the computing unit 3 ascertains, by evaluating the sequence S of depth images B1, whether and, if appropriate, what changes regarding the orientation of the at least one finger 17 of the user 5 relative to the midpoint 15 of the volume region 14 the user 5 has performed. Since step S54 is performed in the yes branch of step S53, the ascertaining takes place after the grasping of the volume region 14 by the user 5, that is to say in the state in which the user 5 holds the volume region 14 in his/her grasp.

In a step S55, the computing unit 3 varies the perspective representation B2 of the three-dimensional structure 4 output via the display device 2. The computing unit 3 ascertains the variation on the basis of the changes performed after the grasping of the volume region 14 regarding the orientation of the at least one finger 17 of the user 5. In particular, the computing unit 3 performs the variation generally in such a way that the rotation of the three-dimensional structure 4 about the midpoint 12 of the sphere 11 corresponds 1:1 to the changes regarding the orientation of the at least one finger 17 of the user 5 relative to the midpoint 15 of the volume region 14.

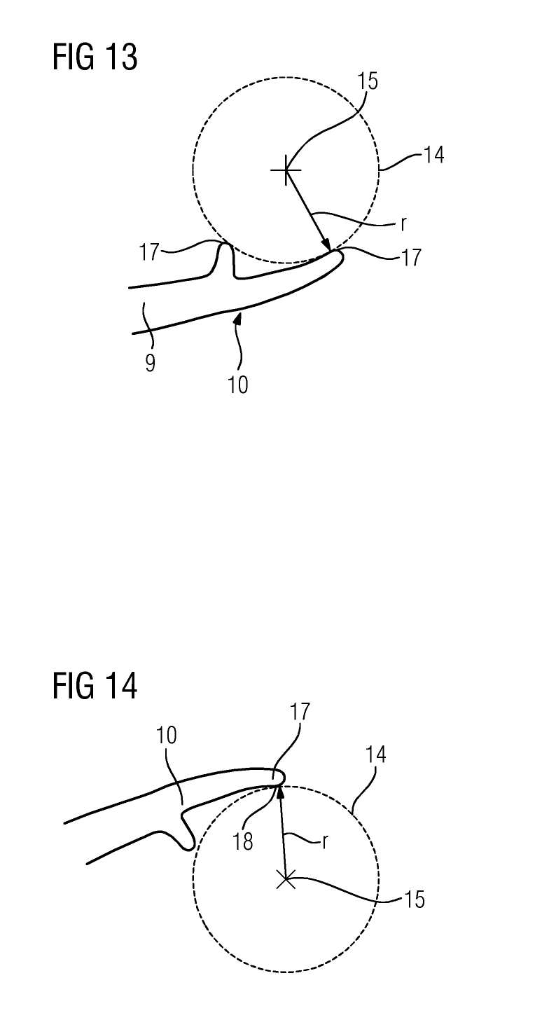

The grasping and the release of the volume region 14 by the user 5 can be ascertained by the computing unit 3 for example by virtue of the fact that the computing unit—see FIG. 13—on the basis of the sequence S of depth images B1 identifies grasping and release of the volume region 14 as a whole. Changes regarding the orientation of the at least one finger 17 of the user 5 in relation to the midpoint 15 of the volume region 14 can be ascertained by the computing unit 3 in this case for example by virtue of the fact that the computing unit ascertains rotation of the at least one hand 10 of the user 5 as a whole.

Alternatively, it is possible that the computing unit 3 in accordance with FIG. 14 ascertains grasping and release of the volume region 14 by virtue of the fact that the computing unit identifies, on the basis of the sequence S of depth images B1, if the user 5 touches or releases a point 18 of the surface of the volume region 14 with at least one finger 17. By way of example, the user 5 can “grasp” the corresponding point of the surface virtually with two or more fingers 17 in the way that said user could grasp an operating lever of a small joystick. The touched point 18 of the surface corresponds to a point 19 of the surface of the sphere 11 (see FIG. 10). Changes regarding the orientation of the at least one finger 17 in relation to the midpoint 15 of the volume region 14 can be ascertained by the computing unit 3 in this case for example on the basis of changes regarding the position of the at least one finger 17 on the surface of the volume region 14.

If the check in step S53 has a negative outcome, the computing unit 3 undergoes transition to a step S56, in which it performs a different reaction.

It is possible to supplement the procedure in FIG. 12 by steps S57 and S58. However, steps S57 and S58 are merely optional and therefore illustrated by dashed lines in FIG. 12. In step S57, the computing unit 3 ascertains whether a distance r between the at least one finger 17 and the midpoint 15 of the volume region 14 has changed. If this is the case, the user 5 has performed a movement toward or away from the midpoint 15 of the volume region 14 with the at least one finger 17 of his/her hand 10. If the computing unit 3 identifies such a change in step S57, in step S58 the computing unit 3 varies a scaling factor in a manner dependent on the movement identified by the computing unit. The computing unit 3 uses the scaling factor when ascertaining the representation B2. The scaling factor corresponds to a zoom factor.

Analogously to the procedure in accordance with FIG. 11, in the case of the procedure in accordance with FIG. 12, too, steps S59 and S60 can be present. In steps S59 and S60-analogously to step S42 from FIG. 11—the computing unit 3 inserts the rotation axis 16 into the perspective representation B2 of the three-dimensional structure 4. However, steps S59 and S60—analogously to step S42 from FIG. 11—are merely optional and therefore illustrated by dashed lines in FIG. 12.

The present invention has many advantages. In particular, comprehensive gesture control of the computing unit 3 is possible in a simple, intuitive and reliable manner. This applies both specifically to rotations of a three-dimensional structure 4 and generally to image manipulations and to global system interactions. Furthermore, in general the entire gesture control is possible with only one hand 10. Both hands 10 are required only in very rare exceptional cases.

Although the invention has been more specifically illustrated and described in detail by the preferred exemplary embodiment, the invention is nevertheless not restricted by the examples disclosed, and other variations can be derived therefrom by a person skilled in the art, without departing from the scope of protection of the invention.

### LIST OF REFERENCE SIGNS

1 Image capture device
2 Display device
3 Computing unit
4 Structure
5 User
6 Selection menu
7 Menu items
8 Image regions
9 Arm
10 Hand
11 Sphere
12 Midpoint of the sphere
13 Grid
14 Volume region
15 Midpoint of the volume region
16 Rotation axis
17 Finger
18 Point of the surface of the volume region
19 Point of the surface of the sphere
B1 Depth images
B2 Output images
C User command
d Diameter
r Distance
s Sequence of depth images
S1 to S60 Steps

What is claimed is:

1. A control method for a computing unit, comprising:
outputting, from the computing unit and via a display device, a perspective representation of a three-dimensional structure to a user of the computing unit;
capturing, using an image capture device, a sequence of depth images and communicating the sequence of depth images to the computing unit;
defining, using the computing unit, a sphere, a midpoint of the sphere lying within the three-dimensional structure;
determining, by the computing unit, a spherical volume region corresponding to the sphere and lying in front of the display device and the midpoint of the spherical volume region; and
ascertaining, by the computing unit and on the basis of the sequence of depth images, whether the user performs a grasping movement with regard to the volume region and, depending on the grasping movement, varying the perspective representation of the three-dimensional structure output via the display device in such a way that the three-dimensional structure rotates about a rotation axis containing the midpoint of the sphere.

2. The control method of claim 1, wherein dependence on the grasping movement resides in the fact that the grasping movement as such initiates the variation of the perspective representation and a release of the grasping movement terminates the variation of the perspective representation.

3. The control method of claim 2, wherein the rotation axis is predetermined or is determined by the computing unit on the basis of the grasping movement or is stipulated for the computing unit by the user by way of a stipulation that differs from the grasping movement.

4. The control method of claim 1, wherein the computing unit
on the basis of the sequence of depth images, ascertains grasping and release of the volume region with fingers of at least one hand of the user and changes made after the grasping of the volume region regarding the orientation of the at least one finger of the user relative to the midpoint of the volume region,
upon the grasping of the volume region ascertains an orientation existing upon the grasping of the volume region regarding at least one finger of the user relative to the midpoint of the volume region,
on the basis of the changes made after the grasping of the volume region regarding the orientation of the at least one finger of the user, varies the perspective representation of the three-dimensional structure that is output via the display device in such a way that the rotation of the three-dimensional structure about the midpoint of the sphere corresponds to the changes made after the grasping of the volume region regarding the orientation of the at least one finger of the user, and
terminates the variation of the perspective representation upon the release of the volume region.

5. The control method of claim 4, wherein the computing unit ascertains grasping and release of the volume region by identifying grasping and release of the volume region as a whole on the basis of the sequence of depth images, and wherein the computing unit ascertains changes regarding the orientation of the at least one finger of the user as a result of a rotation of the at least one hand of the user as a whole.

6. The control method of claim 5, wherein the computing unit ascertains grasping and release of the volume region by identifying touching and release of a point of the surface of the volume region on the basis of the sequence of depth images, and wherein the computing unit ascertains changes regarding the orientation of the at least one finger on the basis of changes regarding the position of the at least one finger on the surface of the volume region.

7. The control method of claim 6, wherein the computing unit after the grasping of the volume region, on the basis of the sequence of depth images, additionally ascertains whether the user with the at least one finger of the at least one hand performs a movement toward and away from the midpoint of the volume region, and wherein the computing unit varies a scaling factor, used by said computing unit when ascertaining the representation, in a manner dependent on the movement of the finger toward and away from the midpoint of the volume region.

8. The control method of claim 1, wherein the computing unit inserts into the perspective representation of the three-dimensional structure the midpoint of the sphere and a grid arranged on a surface of the sphere.

9. The control method of claim 8, wherein the computing unit additionally inserts the rotation axis into the perspective representation of the three-dimensional structure.

10. A control method for a computing unit, comprising:
outputting, from the computing unit via a display device, at least one image of a structure to a user of the computing unit;
capturing, using an image capture device, a sequence of depth images and communicating the sequence of depth images to the computing unit;
ascertaining, by the computing unit and on the basis of the sequence of depth images, whether and, if appropriate, at which of a plurality of image regions the user points with an arm or a hand;
inserting manipulation possibilities related to the output image into image regions of the output image using the computing unit on the basis of a user command; and
activating, by the computing unit if appropriate, at least one of the manipulation possibilities in the output image which corresponds to the image region at which the user points.

11. The control method of claim 10, wherein the image regions cover the entire output image in their entirety.

12. The control method of claim 10, wherein the manipulation possibilities are inserted into the output image in a semitransparent manner by the computing unit.

13. The control method of claim 10, wherein the computing unit, before inserting the manipulation possibilities into the output image, ascertains from a totality of manipulation possibilities implementable in principle those manipulation possibilities which are implementable with regard to the output image, and wherein the computing unit inserts exclusively the implementable manipulation possibilities into the output image.

14. The control method of claim 10, wherein the image regions which adjoin one another are inserted into the output image in at least one of mutually different colors and mutually different brightnesses.

15. The control method of claim 10, wherein
the computing unit outputs via the display device, in addition to the image of the structure, at least one of at least one further image of the structure and a further image of a different structure to the user of the computing unit,
manipulation possibilities related to the further image are also inserted into image regions of the further image by the computing unit on the basis of the user command,
the computing unit ascertains on the basis of the sequence of depth images whether and, if appropriate, at which of the image regions of the further image the user points with the arm or the hand, and
the computing unit activates, if appropriate, the manipulation possibility, corresponding to the image region at which the user points, in the image in which the relevant image region is arranged.

16. A control method for a computing unit, comprising:
outputting, from the computing unit and via a display device, at least one image of a structure to a user of the computing unit;
capturing, using an image capture device, a sequence of depth images and communicating the sequence of depth images to the computing unit;
ascertaining, by the computing unit and on the basis of the sequence of depth images, whether the user performs a predefined gesture that differs from pointing at the output image or an image region of the output image; and
performing an action, by the computing unit, upon the computer device ascertaining that the user performs the predefined gesture, wherein the action is an action that differs from a manipulation of the output image.

17. The control method of claim 16, wherein the action is transferring the computing unit into a state, and wherein the state is independent of the output image or is the same for the output image and at least one further image which can be output as an alternative to the output image.

18. The control method of claim 17, wherein the state is calling up a selection menu having a plurality of menu items, and wherein the menu items can be chosen by the user by pointing at the respective menu item.

19. The control method of claim 18, wherein the selection menu is inserted into the output image by the computing unit.

20. The control method of claim 19, wherein the selection menu is inserted into the output image in a semitransparent manner by the computing unit.

21. The control method of claim 19, wherein the selection menu is inserted into the output image as a circle by the computing unit, and wherein the menu items are represented as sectors of the circle.

22. The control method of claim 18, wherein the computing unit waits for a confirmation by the user after one of the menu items has been chosen, and wherein the chosen menu item is implemented by the computing unit only following stipulation of the confirmation by the user.

23. The control method of claim 22, wherein the confirmation is embodied as stipulation of a predetermined gesture by the user, as a command of the user that differs from a gesture, or as the elapsing of a waiting time.

24. A computer device, comprising:
a computer device including an image capture device, a display device and a computing unit, the computing unit being connected to the image capture device and the display device for the purpose of exchanging data, wherein the computing unit, the image capture device and the display device interact with one another in accordance with the control method of claim 1.

25. The control method of claim 2, wherein the computing unit inserts into the perspective representation of the three-dimensional structure the midpoint of the sphere and a grid arranged on a surface of the sphere.

26. The control method of claim 25, wherein the computing unit additionally inserts the rotation axis into the perspective representation of the three-dimensional structure.

27. The control method of claim 20, wherein the selection menu is inserted into the output image as a circle by the computing unit, and wherein the menu items are represented as sectors of the circle.

28. A computer device, comprising:
a computer device including an image capture device, a display device and a computing unit, the computing unit being connected to the image capture device and the display device for the purpose of exchanging data, wherein the computing unit, the image capture device and the display device interact with one another in accordance with the control method of claim 10.

29. A computer device, comprising:
a computer device including an image capture device, a display device and a computing unit, the computing unit being connected to the image capture device and the display device for the purpose of exchanging data, wherein the computing unit, the image capture device and the display device interact with one another in accordance with the control method of claim 16.

30. A computer readable medium including program code segments for, when executed on a programmable segmentation system, causing the programmable segmentation system to implement the method of claim 1.

31. A computer readable medium including program code segments for, when executed on a programmable segmentation system, causing the programmable segmentation system to implement the method of claim 10.

32. A computer readable medium including program code segments for, when executed on a programmable segmentation system, causing the programmable segmentation system to implement the method of claim 16.
